(19) United States
(12) Patent Application Publication
(10) Pub. No.: US 2026/0298390 A1
(43) Pub. Date: Oct. 1, 2026

(54) PLUGGING HEAD EQUALIZER VALVE

(71) Applicant: SAUDI ARABIAN OIL COMPANY, Dhahran (SA)

(72) Inventor: Ahmed Alakkas, AI Hofuf (SA)

(73) Assignee: SAUDI ARABIAN OIL COMPANY, Dhahran (SA)

(21) Appl. No.: 19/092,203

(22) Filed: Mar. 27, 2025

(51) Int. Cl. F16L 55/11; F16L 41/04; F16L 55/105

(52) U.S. Cl. CPC F16L 55/11; F16L 55/105; F16L 41/04

(57) ABSTRACT

A pipeline plugging system includes a containment machine. The containment machine includes a containment machine housing connected to a pipeline, a plugging head assembly, and a retractable arm coupling the plugging head assembly to an actuator. The plugging head assembly includes a plugging head disposed within the pipeline, a seal positioned radially around the plugging head, a channel fluidly connecting a first and second opening at a first and second axial end of the plugging head, respectively, and a first equalizer valve positioned on the plugging head and fluidly connected to the channel. A method for plugging a pipeline includes extending and sealing a plugging head within a pipeline and operating a first equalizer valve on the plugging head.

### BACKGROUND

In the field of oil and gas, hot tapping and plugging operations are regularly conducted in pipeline networks for repairs or expansions to be completed without depressurizing the network. Hot tapping (sometimes referred to as pressure tapping) refers to the process of tapping (e.g., drilling) into a live pipe to make a connection without having to empty that section of the live pipe. Hot tapping tools typically include a tee fitted around the live pipe, a tapping tool that drills into the live pipe to fluidly connect the interiors of the live pipe and tee, and a valve placed over the hot tap connection to prevent leakage. After hot tapping, a plugging tool is commonly inserted into the live pipe through the hot tap connection. A plugging tool may include a plugging head which isolates a portion of the pipeline.

After a repair or expansion has been completed, the pipeline can be returned to full operation. This process typically involves performing smaller hot tapping operations along the pipeline on either side of the plugging head. Equalization valves are then installed at the hot tapping location and fluidly connected to each other or another section of pipe. Vent valves may be used with the equalization valves to provide greater control over fluid flow. The equalization valves are used to equalize the pressure upstream, i.e., closer to the source of fluid flow, and downstream, i.e., in the section of pipeline without fluid flow, of the plugging head. The equalization valves are also used to fill the isolated segment of pipe with fluid. The plugging head is removed from inside the pipe, the equalization valves are closed, and the plugging tool is disconnected from the pipeline.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, embodiments disclosed herein relate to a pipeline plugging system including a containment machine. The containment machine may include a containment machine housing connected to a pipeline, a plugging head assembly, and a retractable arm coupling the plugging head assembly to an actuator. The plugging head assembly may include a plugging head disposed within the pipeline, a seal positioned radially around the plugging head, a channel extending through the plugging head, and a first equalizer valve positioned along the channel. The channel connects a first opening at a first axial end of the plugging head and a second opening at a second axial end of the plugging head.

In another aspect, embodiments disclosed herein relate to a method for plugging a pipeline. The method may include connecting a containment machine to the pipeline, extending a plugging head from a containment machine housing into the pipeline via a retractable arm, and sealing the plugging head within the pipeline via a seal positioned radially between the plugging head and an inner surface of the pipeline. The method may further include operating a first equalizer valve that is fluidly connected to a channel extending axially through the plugging head. During the extending, sealing, and operating, fluid may be continuously flowed through the pipeline.

In yet another aspect, embodiments disclosed herein relate to a method for plugging a pipeline. The method may include connecting a containment machine to the pipeline, extending a plugging head from a containment machine housing into the pipeline via a retractable arm, and sealing the plugging head within the pipeline via a seal positioned radially between the plugging head and an inner surface of the pipeline. The method may further include opening a first equalizer valve disposed on the plugging head and fluidly connected to a channel extending axially through the plugging head, waiting until a pressure at a first axial end of the plugging head and a pressure at a second axial end of the plugging head are equalized, and retracting the plugging head from the pipeline into the containment machine housing via the retractable arm. The method may further include disconnecting the containment machine from the pipeline.

Any combinations of the various embodiments and implementations disclosed herein can be used in a further embodiment, consistent with the disclosure.

Other aspects and advantages of the claimed subject matter will be apparent from the following description and the appended claims.

### BRIEF DESCRIPTION OF DRAWINGS

FIG. 1A shows an embodiment of a pipeline plugging system with one equalizer valve;

FIG. 1B shows an embodiment of a pipeline plugging system with multiple equalizer valves;

FIG. 2A-2C show a process for inserting a plugging head into a pipeline in accordance with one or more embodiments;

FIG. 3A-3C show several embodiments of a plugging head;

FIG. 4A-4D show examples of how pressure may be released in a pipe using several embodiments of a pipeline plugging system;

FIG. 5 shows an example of how pressure may be measured in a pipe using an embodiment of a pipeline plugging system;

FIG. 6 shows a flowchart in accordance with one or more embodiments;

FIG. 7 shows a flowchart in accordance with one or more embodiments.

### DETAILED DESCRIPTION

Specific embodiments of the disclosed technology will now be described in detail with reference to the accompanying figures. Like elements in the various figures are denoted by like reference numerals for consistency. The sizes and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn are not necessarily intended to convey any information regarding the actual shape of the particular elements and have been solely selected for ease of recognition in the drawing.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

In one aspect, embodiments disclosed herein relate to systems and methods for equalizing the pressure around a plugging head in a pipeline network. A plugging head may be provided as part of a containment machine, which may be connected to a hot tap connection on a live pipe. With the containment machine connected, the plugging head may be inserted from the containment machine, through the hot tap connection, into the pipe to perform a line stopping (i.e., plugging) operation. Line stopping or plugging operations may include inserting a plugging head into a pipe for isolating a portion of the pipe and providing an equalizer valve where none previously existed.

For example, in the oil and gas industry, when a pipeline needs repair or additions, hot tapping may be conducted on the pipeline to tap into the pipeline. During hot tapping, a hot tap assembly may be installed around a section of the desired pipe. The hot tap assembly may include a tee which may serve as a connection point to the pipeline. The tee may be used to connect tapping equipment to the pipeline as well as subsequent line stopping equipment to the pipeline. Hot tapping equipment may include a hole saw, which may be inserted through the open portion of the tee to cut an opening in the pipe. A bidirectional valve may be placed over the opening in the pipe, e.g., connected directly to the tee, to prevent leakage and provide access to the interior of the pipe. A containment machine may then be attached to the tee (e.g., via connection to the bidirectional valve), and the bidirectional valve to the pipe may be opened. A plugging head may be inserted into the cut opening of the pipe to plug the pipe. The plugging head may include an equalizer valve in fluid connection with the fluid flow through the pipe. In some line stopping operations, two containment machine assemblies may be installed around a section of pipe, and plugging heads may be inserted through each assembly to isolate the section of pipe between the assemblies. Once the isolated section of pipe is serviced or replaced, the equalizer valve in each plugging head may be opened to equalize the pressure upstream and downstream of the plugging head. The plugging head may then be removed from the pipe and the containment machine may be detached from the pipeline. Systems and methods disclosed herein include pipeline plugging systems capable of isolating a section of pipe using a plugging head and equalizing the pressure around the plugging head using an equalizer valve.

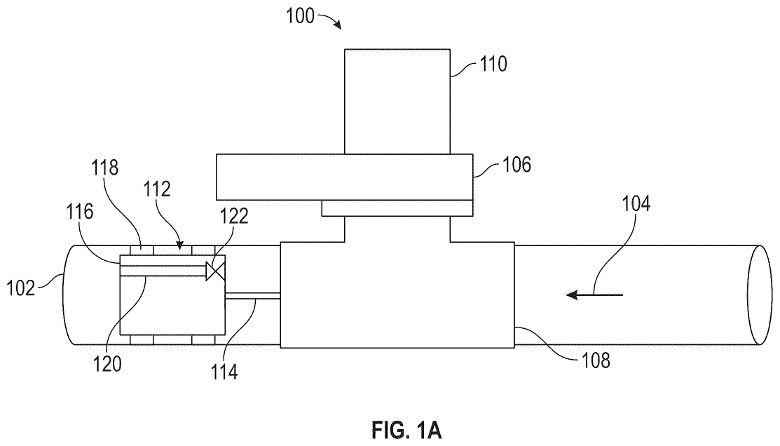

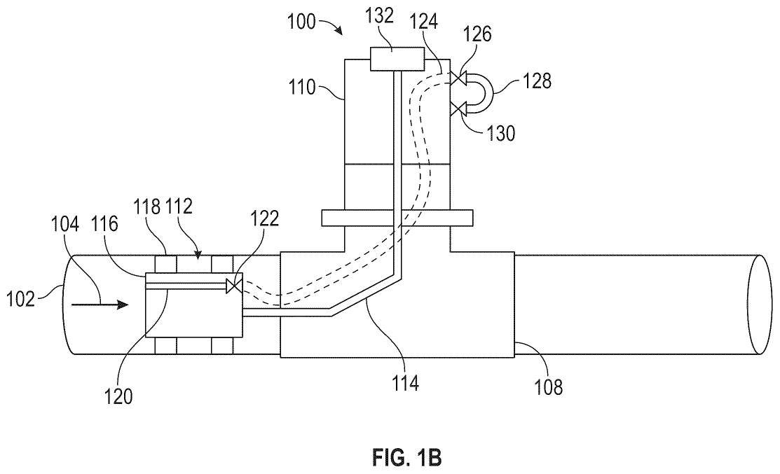

FIGS. 1A and 1B show pipeline plugging systems in accordance with one or more embodiments. The pipeline plugging systems may be used on one or more pipelines, e.g., in order to perform line stopping operations to replace, fix, or expand sections of the pipeline. The pipeline plugging systems may be used on different types of piping networks including pipelines servicing water, crude oil, gas, and/or chemicals. The pipeline plugging systems in FIGS. 1A and 1B depict illustrative examples of how a containment machine (100) according to embodiments of the present disclosure may be used with a pipe (102) in a pipeline employed, for example, in oil and gas operations. Accordingly, the fluid flow (104) through the pipe (102) may include hydrocarbons as part of a petroleum transportation system. However, it will be appreciated that pipeline plugging systems according to embodiments of the present disclosure may be used with numerous pipeline systems and operations and are not limited to use in the examples shown in FIGS. 1A and 1B.

A cross-sectional view of a pipe (102) with an example of a pipeline plugging system is shown in FIG. 1A. The pipeline plugging system includes a pipe (102), valve assembly (106), and containment machine (100) in accordance with one or more embodiments. The containment machine (100) may be connected to the pipe (102) by the valve assembly (106), e.g., via a flange connection. The valve assembly (106) may include a bidirectional valve, which when open, may provide access to the interior of the pipeline. The valve assembly (106) may be attached to the pipe (102) via a tee (108) such as a split tee. The tee (108) may be part of the original pipeline or may be added to the pipeline before performing a plugging operation.

FIG. 1A shows a containment machine (100) attached to a valve assembly (106). For example, a flange or a clamp with a locking mechanism may be used to attach a containment machine housing (110) to the valve assembly (106). In some embodiments, a valve may be integrally provided with the containment machine.

The containment machine (100) according to embodiments of the present disclosure may include a containment machine housing (110), a plugging head assembly (112), and a retractable arm (114). In accordance with one or more embodiments, a retractable arm may be a bendable clock spring tube or a fixable high pressure hose with a retractable reel. The plugging head assembly (112) and retractable arm (114) may be stored in the containment machine housing (110) when the pipeline plugging system is not actively in use. When a plugging operation is needed, the retractable arm (114) may be used to position the plugging head assembly (112) in a pipe (102).

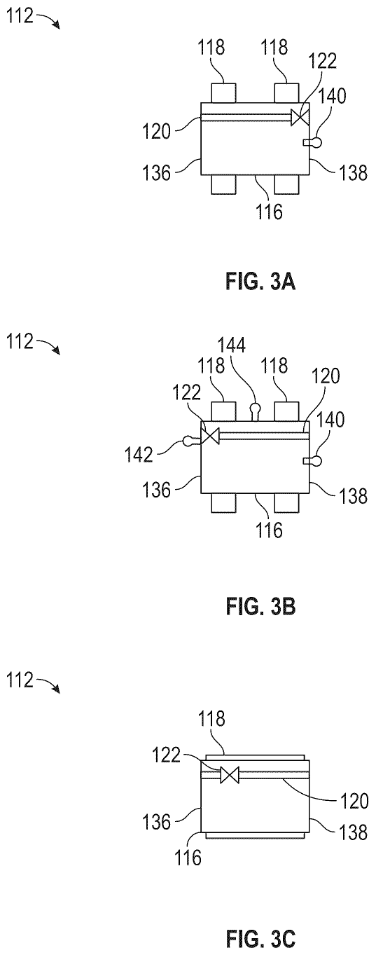

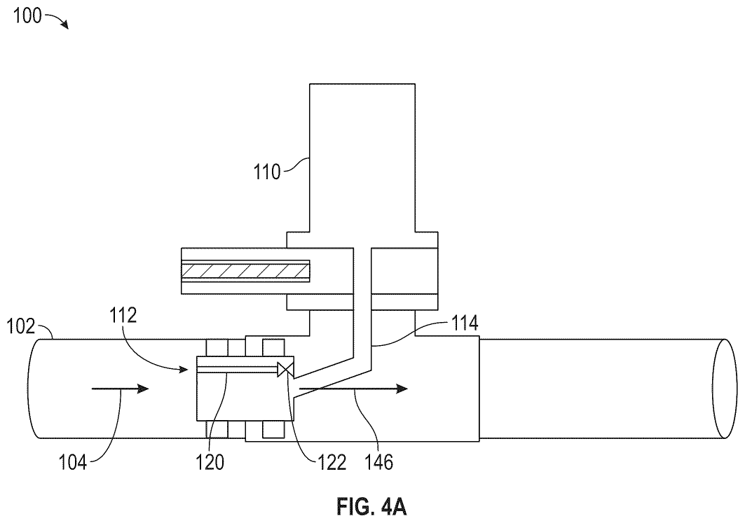

A containment machine housing (110), valve assembly (106), and tee (108) are shown as additional components connected to the pipe according to one or more embodiments in FIG. 1A. A plugging head assembly (112) is shown deployed in the pipe (102) while fluid flow (104) continues in the pipe (102). The plugging head assembly (112) is shown downstream of the containment machine connection for illustrative purposes only. The pipeline plugging system may also be used if the direction of fluid flow (104) is reversed or otherwise changed. The plugging head assembly (112) includes a plugging head (116), at least one seal (118), a channel (120), and a first equalizer valve (122). The plugging head assembly (112) is described in further detail in FIGS. 3A-3C.

FIG. 1B shows a cross-sectional view of a pipe (102), containment machine housing (110), and tee (108) with a plugging head assembly (112) in accordance with one or more embodiments. In this view, an example of a retractable arm (114) can be seen connecting the containment machine housing (110) to the plugging head (116). The retractable arm may (114) have one or more joints which allow it to be extended or retracted. Telescopic extension and other mechanisms may also be used, together with one or more joints or instead of one or more joints, to extend and retract the retractable arm (114). Additionally, the retractable arm can be welded or detachably connected, e.g., using screws, to the containment machine housing (110) and plugging head (116). The retractable arm (114) may be moved (e.g., extended or retracted) by an actuator (132). The actuator (132) may be a powered actuator (e.g., electrical, hydraulic, pneumatic, etc.) or a manual actuator (e.g., handwheel, lever, etc.).

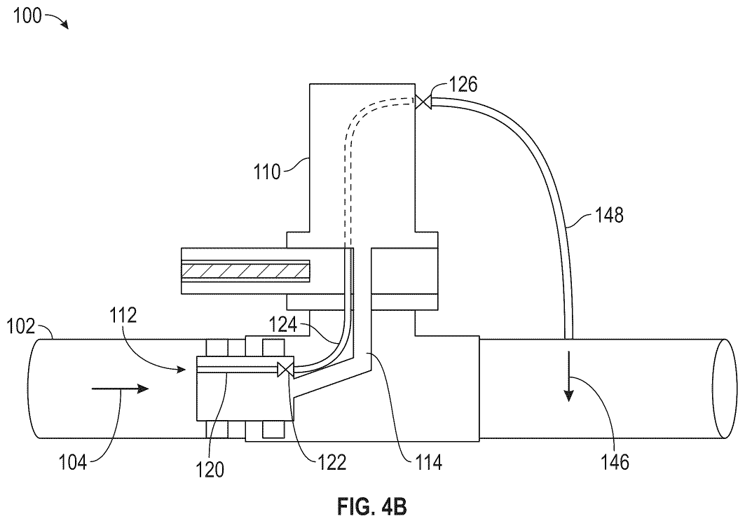

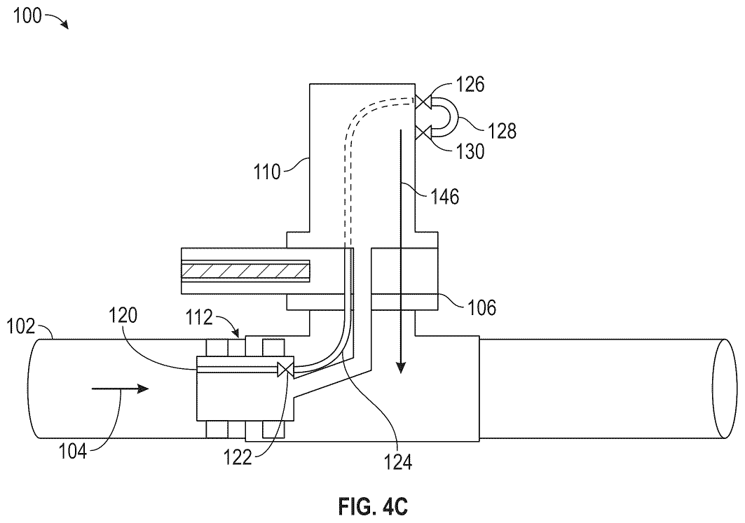

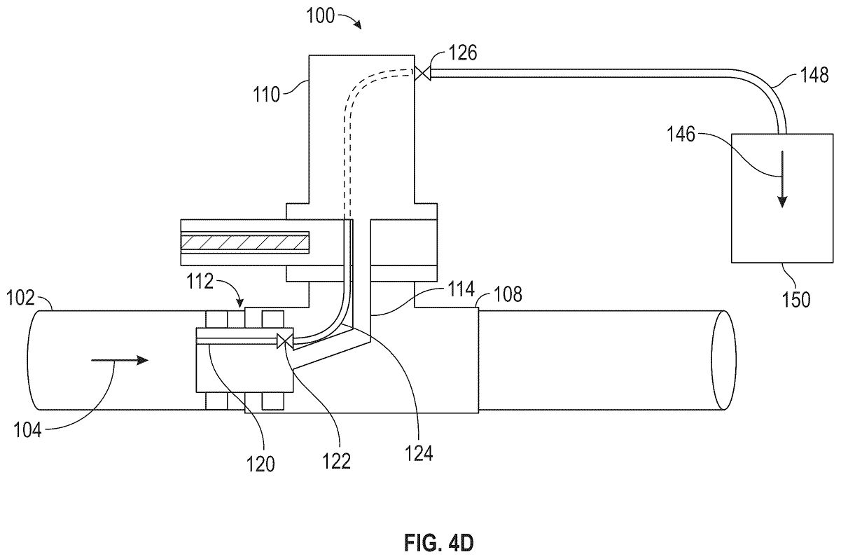

The plugging head assembly (112) in FIG. 1B is shown upstream of the containment machine connection. The plugging head assembly (112) includes a plugging head (116), at least one seal (118), a channel (120), and a first equalizer valve (122). The pipeline plugging system may further include one or more of a first hose (124), a second equalizer valve (126), a second hose (128), a third equalizer valve (130), or some combination of these components, in accordance with embodiments of the present disclosure. In some embodiments, for example, a first equalizer valve (122) may be connected to a second equalizer valve (126) using a first hose (124). The first hose (124) may be connected to the retractable arm (114), for example, using one or more clamps, to prevent the first hose (124) from becoming tangled when the retractable arm (114) is extended or retracted. The first hose (124), second equalizer valve (126), second hose (128), and third equalizer valve (130) are described in further detail in FIGS. 4A-4D.

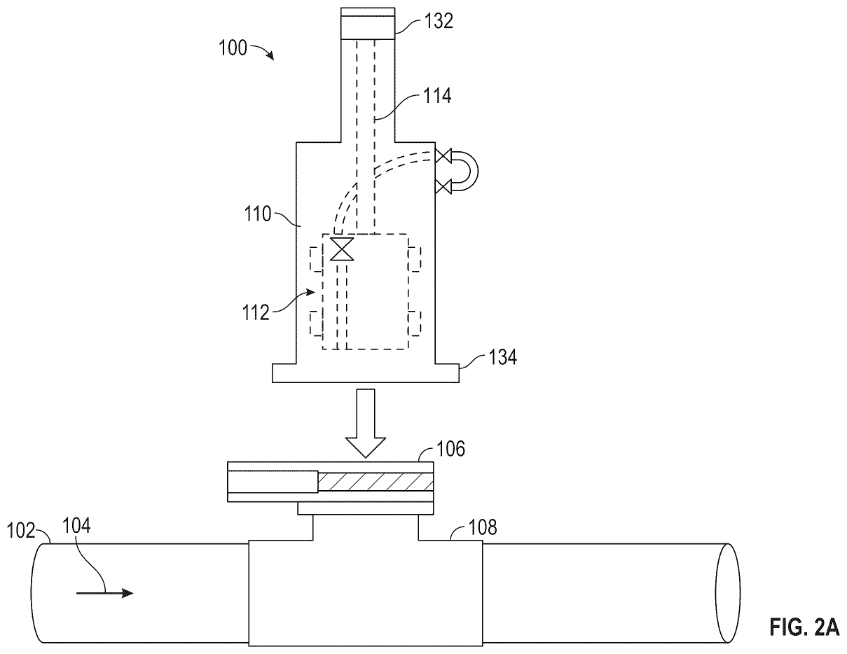

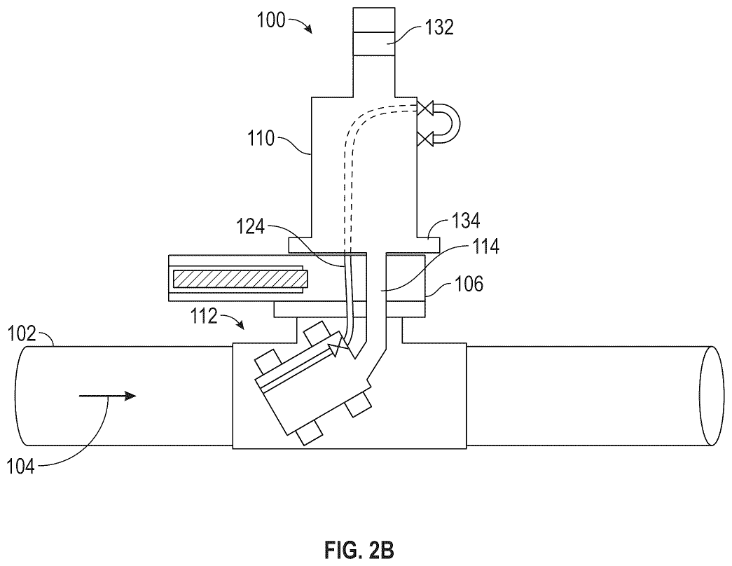

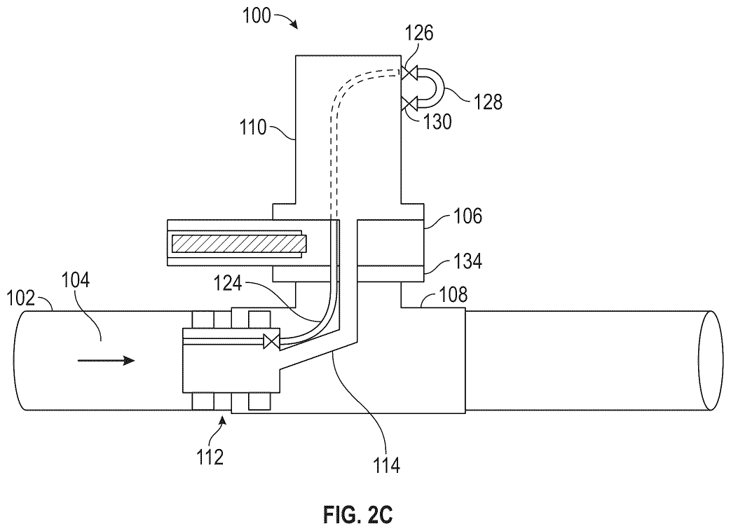

An example of a process for using a pipeline plugging system to insert a plugging head assembly (112) into a pipeline is shown in FIGS. 2A-C. In FIG. 2A, a pipeline is shown after it has been hot tapped. A tee (108) and valve assembly (106) are positioned on a pipe (102), and fluid flow (104) is uninterrupted through the pipe (102). The valve assembly (106) is in a closed configuration to prevent fluid leakage. A containment machine (100) may be connected to the valve assembly (106) using a flange connection (134) in one or more embodiments, or other types of connections known in the art. Until the containment machine (100) is connected to the pipeline, the actuator (132) is inactive. The retractable arm (114) and plugging head assembly (112) are stored inside the containment machine housing (110).

FIG. 2B shows the containment machine (100) after it has been connected to the pipeline. With the flange connection (134) in place, and fasteners connecting the containment machine flange to the valve assembly (106), the valve may be opened to allow access to the pipeline. The valve may be a gate valve (e.g., a sandwich-type gate valve commonly used with hot tapping operations), which may be hydraulically actuated to move the valve's gate transversely into and out of the flow path through the valve to seal and open the flow path, respectively.

The containment machine's actuator (132) may move the retractable arm (114) downward to remove the plugging head assembly (112) from the containment machine housing (110) and insert the plugging head assembly (112) into the pipeline. A connected first hose (124) may be pulled downward with the plugging head assembly (112). During this part of the process, fluid flow (104) may continue through the pipeline.

FIG. 2C shows a plugging head assembly (112) sealed within a pipeline. The valve assembly (106) remains open as the retractable arm (114) moves further into the pipe (102), positioning the plugging head assembly (112) to sealingly engage with the interior surface of the pipeline. Once the plugging head assembly (112) is sealed within the pipe (102), fluid flow (104) entering the pipe (102) may be blocked from continuing through the pipe (102). The sealed-off part of the pipeline not experiencing fluid flow (104) may be accessed for a pipe operation such as routine maintenance, retrieval of a stuck tool or debris, pipeline rerouting, or pipe replacement.

After the pipe operation is complete, the pressure may be equalized on either side of the plugging head assembly (112). Pressure equalization may occur using only the plugging head assembly (112) or using the plugging head assembly (112) in some combination with one or more hoses, valves, and passages in accordance with embodiments of the present disclosure. Several embodiments of the pressure equalization process are described in further detail in FIGS. 4A-4D.

Several embodiments of the plugging head assembly (112) are shown in FIGS. 3A-C as cross-sectional views. The plugging head assembly (112) includes a plugging head (116) which blocks the flow of fluid. In one or more embodiments, the plugging head (116) may be made of carbon steel. The plugging head (116) is radially surrounded by a seal (118). When the seal (118) is activated, it seals the plugging head within a pipe, thereby preventing fluid from flowing between the plugging head and the interior surface of the pipe. As shown in FIG. 3A, multiple seals may be provided around the radial perimeter of the plugging head, e.g., multiple O-ring seals, rubber seals, metallic seals, or nonmetallic soft seals. A channel (120) may be in fluid connection with a first opening at a first axial end of the plugging head (138) and a second opening at a second axial end of the plugging head (136). The channel (120) is shown as straight in FIG. 3A, but a person of skill will appreciate that many different types and shapes of channels may be used to fluidly connect the two axial ends of the plugging head (116).

A first equalizer valve (122) may be placed in fluid connection with the channel (120). The embodiment shown in FIG. 3A shows the first equalizer valve positioned in a port to the channel (120) proximate the first axial end of the plugging head; however, a first equalizer valve may be fluidly connected to the channel in other locations either within or outside of the plugging head. A solenoid valve, remotely operated valve, or other type of valve may be used for the first equalizer valve (122). The first equalizer valve (122) is kept closed during an operation on the pipe. After an operation is complete, the first equalizer valve (122) may be opened to equalize the pressure on either side of the plugging head (116). A pressure measurement port (140) may be included in the plugging head assembly (112). The pressure measurement port (140) may serve as a connection to a pressure gauge and as a fluid inlet. The pressure measurement port (140) may be fluidly connected to both the volume interfacing the first axial end of the plugging head (e.g., via an opening to the first axial end of the plugging head) and to a pressure measurement device (e.g., via one or more passages through the plugging head body and/or a hose), such that the pressure measurement device (e.g., a pressure gauge) may measure the pressure of the volume interfacing the first axial end of the plugging head via the pressure measurement port.

Pressure measurements taken using the first pressure measurement port (140) may be used to determine when to operate the first equalizer valve (122). For example, the pressure measurements taken from the first pressure measurement port (140) immediately after the first equalizer valve is opened will likely fluctuate dramatically as pressure from a second axial end of the plugging head (136) is released to the first axial end of the plugging head (138). As the pressure between the two ends of the plugging head equalizes, the pressure measurements may become more consistent. Once a steady pressure is measured from the first pressure measurement port (140), an equilibrium pressure may be determined to have been obtained. With the equalization process complete, the first equalizer valve (122) may be closed. This is one of many embodiments a person of skill will recognize as possible using the plugging head assembly (112).

The plugging head assembly (112) embodiment in FIG. 3B shows another option for including pressure measurement ports in the plugging head assembly (112). A pressure measurement port (140) is depicted on a first axial end of the plugging head, and a second pressure measurement port (142) is depicted on a second axial end of the plugging head (136). The pressure measurement ports (140, 142) may open to and be fluidly connected to the volumes interfacing the first and second axial ends of the plugging head, respectively. Further, the pressure measurement ports (140, 142) may be fluidly connected to respective pressure measurement devices, e.g., via one or more passages through the plugging head body and/or a hose, such that the pressure measurement devices may measure the pressure of the volume interfacing the respective axial end of the plugging head via the pressure measurement port.

A first equalizer valve (122) is depicted in fluid connection with the channel (120) at the second axial end of the plugging head. The first and second pressure measurement ports make possible pressure measurements at both axial ends of the plugging head (116). Pressure measurements at both axial ends of the plugging head (116) may be used to observe the difference in pressure around the plugging head (116). When the pressure measurements are different from each other, e.g., when the first equalizer valve (122) is closed, it may be determined that pressure around the plugging head (116) is not equalized. When the pressure measurements are close to or match each other, e.g., when the first equalizer valve (122) is open, it may be determined that the pressure around the plugging head (116) is equalized. The difference between the pressure measurement using the first pressure measurement port (140) and the pressure measurement using the second pressure measurement port (142) may inform the operation of the first equalizer valve (122). In some embodiments, the pressure measurements may be used to control the operation of the first equalizer valve (122). For example, an instrumentation control panel and/or a programmable logic controller may be used to automate an equalization process by sending instructions to open/close an equalizer valve at a given time and/or measured pressure.

The plugging head assembly (112) embodiment in FIG. 3B further shows a seal pressure measurement port (144) placed within the seal (118). The seal measurement port (144) may, for example, be placed between two seals radially surrounding the plugging head (116). The seal pressure measurement port (144) may fluidly connect a sealed volume between the seals to a seal pressure gauge (156), e.g., via one or more passages through the plugging head body and/or a hose. The seal pressure measurement port (144) may be used to monitor pressure changes within the seal (118) which may occur when fluid passes between a pipe (102) and the seal (118). Pressure changes within the seal (118) may indicate a faulty seal or failed sealing activation. In some embodiments, the pressure measurement taken from the seal pressure measurement port (144) may be used to determine whether a seal has been properly activated and/or whether an operation may be safely performed within an isolated segment of pipe.

The plugging head assembly (112) embodiment in FIG. 3C shows another example of the many possible variations in seal (118) type and first equalizer valve (122) location that could be used. The seal (118) is depicted as a single seal member wrapped around the plugging head (116). The seal (118) may be made of rubber, polyurethane, neoprene, or any other material or composite of materials known in the art. The first equalizer valve (122) is shown in the middle of the plugging head (116), rather than at an axial end of the plugging head (116). As in other embodiments, the first equalizer valve (122) is in fluid connection with the channel (120).

For more complex systems, such as those requiring double block valves, more than one first equalizer valve (122) may be added to the plugging head assembly (112). Each first equalizer valve (122) may be operated in fluid connection with its own channel (120) through the plugging head (116). A benefit to using more than one first equalizer valve (122) may be increased reliability of the plugging head assembly (112). For example, if one first equalizer valve (122) fails, a back-up first equalizer valve could be operated.

Several embodiments of a pipeline plugging system used for pressure release are shown in FIGS. 4A-4D. In FIGS. 4A-4D, a containment machine (100) is connected to a pipe (102), a plugging head assembly (112) is deployed from the containment machine housing (110), and the plugging head assembly (112) is sealed in the pipe (102).

FIG. 4A shows an embodiment of a pipeline plugging system using one equalizer valve, i.e., the first equalizer valve (122), to release (e.g., vent) pressure around the plugging head assembly (112). Before the first equalizer valve (122) is open, fluid flow (104) is blocked by the plugging head assembly (112) sealed within the pipe (102). Once the first equalizer valve (122) is open, there is a pressure release fluid flow (146) through the first equalizer valve (122). The pressure release occurs as fluid flow (104) travels through the channel (120) and out of the open first equalizer valve (122). Eventually the downstream segment of pipe (102) which had been isolated from fluid flow (104) fills with fluid. When the downstream segment of pipe (102) is filled, either partially or completely, and fluid is on both sides of the plugging head assembly (112), pressure may be equalized around the plugging head assembly (112). The plugging head assembly (112) may then be removed from the pipe (102).

Pressure equalization prevents the plugging head assembly (112) from getting stuck in the pipe (102) or damaging the pipe (102) during removal. If pressure is not equalized, then the pressure from the fluid flow (104) builds up on one side of the plugging head assembly (112). As a result, the plugging head assembly (112) may experience a large force from the pressure buildup when the retractable arm (114) retracts. This force may damage not only the plugging head assembly (112) but also the pipeline, containment machine, and any personnel present by the pipe (102). Accordingly, pressure equalization before removal of the plugging head assembly (112) may increase the safety of the plugging head removal process and decrease risks associated with this process.

The use of a first equalizer valve (122) to perform pressure equalization has advantages over the conventional method. Because the first equalizer valve (122) is part of the plugging head assembly (112), an equalizer valve is not needed in the pipe (102). This eliminates the need for a separate hot tapping operation in the pipe (102) to create a vent, increasing operational efficiency and eliminating a weak point, e.g., vent, in the pipe (102) which may fail in the future. The first equalizer valve (122) also removes the need for an equalizer valve to be permanently installed in the vent. As a result, the first equalizer valve (122) wastes fewer materials and operational resources, such as personnel time and equipment power. In the case of an equalizer valve removably installed in the vent, the first equalizer valve (122) removes the need to expend resources plugging the vent after the removal of an equalizer valve from the pipe (102). Additionally, given the danger involved in welding, the use of a first equalizer valve (122) increases the safety of pressure equalization by decreasing the amount of welding required.

Another advantage of the present disclosure is that the first equalizer valve (122) is removed from the pipe (102) after the pipeline operation is complete. Since the first equalizer valve (122) is in the plugging head assembly (112), the first equalizer valve (122) is removed along with the plugging head assembly (112) when the containment machine (100) is disconnected from the pipe (102). The first equalizer valve (122) may easily be reused for many different plugging operations.

FIG. 4B shows an embodiment of a pipeline plugging system for releasing pressure downstream in a pipe (102) using two equalizer valves. The equalizer valves used are the first equalizer valve (122) in the plugging head assembly (112) and a second equalizer valve (126) in the containment machine housing (110). The first equalizer valve (122) is fluidly connected to the second equalizer valve (126) using a first hose (125). The first hose (125) may be part of the containment machine (100) and may be a high-pressure hose, a pipeline, or a channel in the retractable arm (114). The second equalizer valve (126) is fluidly connected to the downstream segment of the pipe (102) using a passage (148), e.g., a high-pressure hose or a temporary pipeline extension. The passage (148) may connect to the pipeline through a hot-tapped vent, threaded union, flange, or other adaptor.

In one or more embodiments, the passage (148) may connect to the pipe (102) upstream from the plugging head assembly (112). The upstream location may release pressure without equalizing the pressure around the plugging head assembly (112). In embodiments where a passage connects an equalizer valve on the containment machine to the pipe being plugged, such passage may be connected to previously installed ports or adapters to the pipe, whether located upstream or downstream of the containment machine.

Before the first equalizer valve (122) is open, fluid flow (104) is blocked by the plugging head assembly (112). Once the first equalizer valve (122) is open, fluid flow (104) travels through the channel (120), the first equalizer valve (122), and the first hose (124). When the second equalizer valve (126) is open, fluid flow (104) will continue to travel through the second equalizer valve (126), through the passage (148), and into the pipe (102). The second equalizer valve (126) may be opened before, after, or at the same time as opening the first equalizer valve (122). The fluid flow (104) reentering the pipe (102) is shown as a pressure release fluid flow (146). Eventually the downstream segment of pipe (102) which had been isolated from fluid flow (104) fills with the pressure release fluid flow (146). When the pipe (102) is filled, either partially or completely, with fluid on both sides of the plugging head assembly (112), pressure may be equalized around the plugging head assembly (112). The plugging head assembly (112) may then be removed from the pipe (102).

The second equalizer valve (126), when used in fluid connection with the first equalizer valve (122), adds a second option for controlling the equalization process. For example, it may be useful to open the first equalizer valve (122) before opening the second equalizer valve (126) if pressure from the fluid flow (104) increases during an operation. This may reduce the pressure on the side of the plugging head assembly (112) in contact with the fluid flow (104) without allowing fluid to enter the isolated segment of pipe (102). As another example, the first equalizer valve (122) and the second equalizer valve (126) may both be partially opened to slowly release the pressure from the fluid flow (104). A person of skill will appreciate the many variations in equalization operation made possible by more than one equalizer valve.

FIG. 4C shows an embodiment of a pipeline plugging system for releasing pressure downstream in a pipe (102) using a first equalizer valve (122) in the plugging head assembly (112) with both a second equalizer valve (126) and a third equalizer valve (130) in the containment machine (100). The first equalizer valve (122) is connected to the second equalizer valve (126) using a first hose (125). The second equalizer valve (126) is connected to the third equalizer valve (130) using a second hose (128). The second equalizer valve (126) and third equalizer valve (130) may be located on the containment machine housing (110), such as depicted in FIG. 4C. Alternatively, the second equalizer valve (126) and third equalizer valve (130) may be located inside the containment machine housing (110). Depending on the location of the second equalizer valve (126) and third equalizer valve (130), the second hose (128) may be located outside the containment machine housing (110), such as depicted in FIG. 4C, or inside the containment machine housing (110).

Before the first equalizer valve (122) is open, fluid flow (104) is blocked by the plugging head assembly (112). Once the first equalizer valve (122) is open, fluid flow (104) travels through the channel (120), the first equalizer valve (122), and the first hose (124). When the second equalizer valve (126) is open, fluid flow (104) continues through the second equalizer valve (126) and the second hose (128). When the third equalizer valve (130) is open, fluid flow (104) continues through the third equalizer valve (130) and into the containment machine housing (110). The first, second, and third equalizer valves may be open at the same time or in any order. The fluid flow (104) entering the containment machine housing (110) is shown as a pressure release fluid flow (146). Since the valve assembly (106) is open, the pressure release fluid flow (146) continues through the containment machine housing (110) and into the pipe (102).

Eventually the downstream segment of pipe (102) which had been isolated from fluid flow (104) fills with the pressure release fluid flow (146). When the pipe (102) is filled, either partially or completely, with fluid on both sides of the plugging head assembly (112), pressure may be equalized around the plugging head assembly (112). The plugging head assembly (112) may then be removed from the pipe (102). As discussed for FIG. 4B, each additional equalization valve provides an additional option for controlling the equalization process.

FIG. 4D shows an embodiment of a pipeline plugging system for releasing pressure into a receptacle (150) using the first equalizer valve (122) in fluid connection with the second equalizer valve (126). The first equalizer valve (122) is fluidly connected to the second equalizer valve (126) using a first hose (125), and the second equalizer valve (126) is fluidly connected to the receptacle (150) using a passage (148). The receptacle (150) may be temporary or permanent, and the receptacle (150) may be one or more holding tanks, reservoirs, vessels, or pipelines. Though the receptacle (150) is depicted in close proximity to the containment machine (100) and pipe (102) in this embodiment, it may also be placed at a farther distance from the containment machine (100) and pipe (102). Further, the receptacle may or may not be fluidly connected to the pipe (102). In one or more embodiments, an equalizer valve (e.g., the first equalizer valve (122) and/or the second equalizer valve (126)) may be a pressure relief valve. In such embodiments, the pressure relief valve may be set to a selected pressure less than an anticipated pressure in the pipe during maintenance and/or may be used in series with a remotely operated equalizer valve.

Before the first equalizer valve (122) is open, fluid flow (104) is blocked by the plugging head assembly (112). Once the first equalizer valve (122) is open, fluid flow (104) travels through the channel (120), the first equalizer valve (122), and the first hose (124). If the second equalizer valve (126) is open, fluid flow (104) continues through the second equalizer valve (126), through the passage (148), and into the receptacle (150). The fluid flow (104) entering the receptacle (150) is shown as a pressure release fluid flow (146). The pressure release fluid flow (146) may be stored in the receptacle (150), discarded as waste, or reused. In on or more embodiments, the pressure release fluid flow (146) may flow directly into a different pipeline or be added back to the pipe (102) after the pipeline operation is complete.

Pressure release without equalization, as described in FIG. 4D, may be advantageous, for example, when the pressure on the plugging head (116) is high enough to cause the plugging head assembly (112) to fail and disconnect from the retractable arm (114). The process of pressure release described in FIG. 4D may decrease the pressure on the plugging head assembly (112) during a pipeline operation. Once the pipeline operation is complete, a pressure equalization process, such as one described in FIG. 4A-4C, may be performed.

It will be appreciated that methods for releasing and/or equalizing pressure described in embodiments of the present disclosure may be used with numerous pipeline plugging systems and are not limited to use in the examples shown in FIGS. 4A-4D.

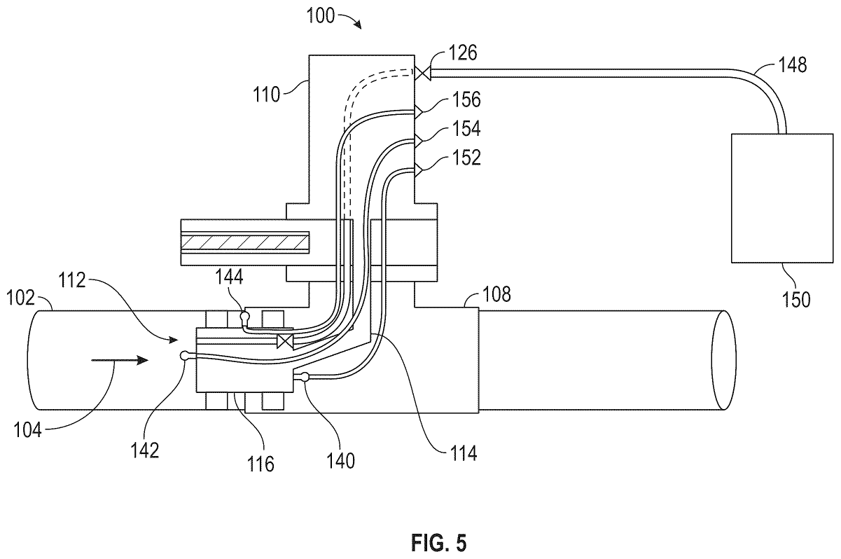

FIG. 5 shows an example of how pressure may be measured in a pipe using an embodiment of a pipeline plugging system. A plugging head assembly (112) is shown with three pressure measurement ports. The first pressure measurement port (140) may be located in the isolated segment of pipe (102). Measurements taken from the first pressure measurement port (140) may be used to monitor the isolated segment of pipe (102), ensuring that it stays isolated during a pipeline operation. The second pressure measurement port may be located on the side of the plugging head assembly (112) in contact with fluid flow (104). Measurements taken from the second pressure measurement port (142) may be used to monitor the pressure buildup on the plugging head (116). The seal pressure measurement port may be located between the plugging head (116) and the inner surface of the pipeline. Measurements taken from the seal pressure measurement port (144) may be used to monitor any fluid leakage through the seal (118).

The first pressure measurement port (140) is fluidly connected to a first pressure gauge (152), the second pressure measurement port (142) is fluidly connected to a second pressure gauge (154), and the seal pressure measurement port (144) is fluidly connected to a seal pressure gauge (156). Each pressure gauge may provide a pressure measurement reading on the containment machine housing (110) and/or may provide the pressure measurement reading to an electronic system. For example, an operator may be able to monitor any given pressure measurement by viewing the corresponding pressure gauge or by viewing an instrumentation control panel screen.

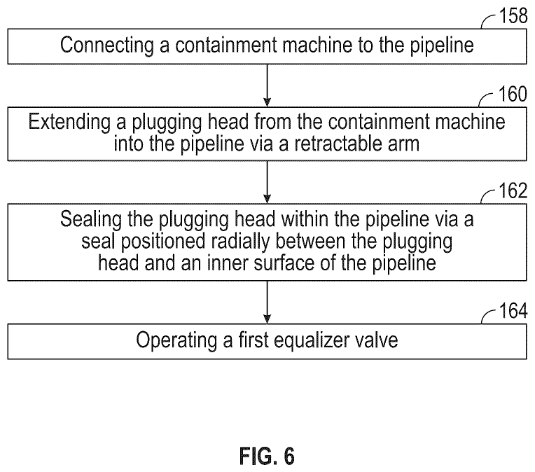

FIG. 6 shows a flowchart in accordance with one or more embodiments. Specifically, FIG. 6 describes methods for operating a first equalizer valve according to embodiments of the present disclosure. One or more blocks in FIG. 6 may be performed by one or more components (e.g., as described in FIGS. 1A and 1B). While the various blocks in FIG. 6 are presented and described sequentially, one of ordinary skill in the art will appreciate that some or all of the blocks may be executed in parallel or non-sequentially. Furthermore, the blocks may be performed actively or passively.

In Block 158, a containment machine is connected to a pipeline. The connection may be made after a hot tapping operation. The containment machine may be connected to a pipe using a flange connection, bolts, and/or other adapters and fasteners. The containment machine includes a plugging head and a retractable arm. In Block 160, a plugging head is extended from the containment machine into the pipeline via a retractable arm. In Block 162, the plugging head is sealed within the pipeline via a seal. The seal is positioned radially between the plugging head and an inner surface of the pipeline. In Block 164, a first equalizer valve is operated.

In accordance with one or more embodiments, the first equalizer valve may be opened when the pressure on one end of the plugging head assembly is above a pressure threshold. The pressure threshold may be based on one or more material failure parameters, such as the pipe pressure rating and/or the seal pressure rating. For example, the pressure threshold may be selected to be a percentage of the seal pressure rating, e.g., between 50% and 90% of the seal pressure rating, etc. In other embodiments, the pressure threshold may be the maximum allowable operating pressure or a pressure selected by an operator based on the parameters of the pipeline operation. When the measured pressure reaches or exceeds the selected pressure threshold, the first equalizer valve may be opened (e.g., automatically or by sending a signal to the equalizer valve). The pressure may be measured, for example, using a pressure measurement device on one or both axial ends of the plugging head assembly and/or other pressure measurement device in fluid communication with the fluid flow in the pipe.

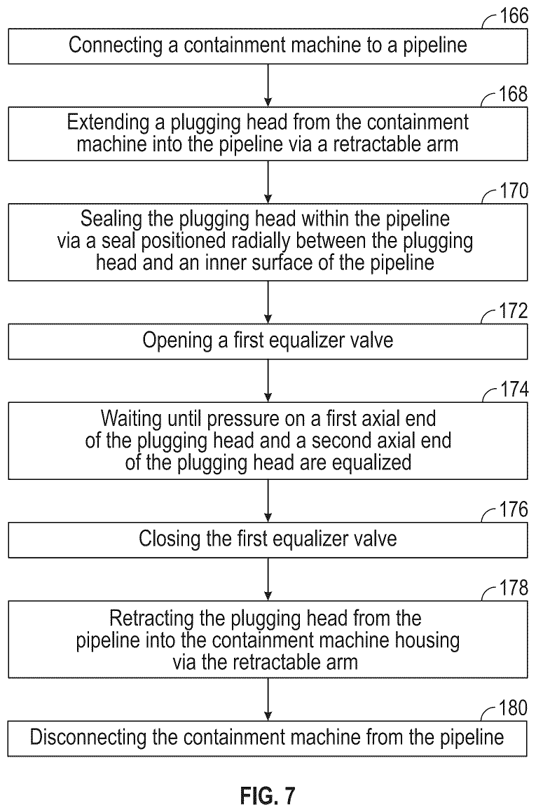

FIG. 7 shows a flowchart in accordance with one or more embodiments. Specifically, FIG. 7 describes methods for equalizing the pressure around a plugging head using a first equalizer valve according to embodiments of the present disclosure. One or more blocks in FIG. 7 may be performed by one or more components (e.g., as described in FIGS. 1A and 1B). While the various blocks in FIG. 7 are presented and described sequentially, one of ordinary skill in the art will appreciate that some or all of the blocks may be executed in parallel or non-sequentially. Furthermore, the blocks may be performed actively or passively.

In Block 166, a containment machine is connected to a pipeline. The connection may be made after a hot tapping operation. The containment machine may be connected to a pipe using a flange and bolt connection or other adapter (e.g., a latching assembly). The containment machine includes a plugging head and a retractable arm. In Block 168, a plugging head is extended from the containment machine into the pipeline via a retractable arm. In Block 170, the plugging head is sealed within the pipeline via a seal. The seal is positioned radially between the plugging head and an inner surface of the pipeline.

In Block 172, a first equalizer valve is opened. In Block 174, there is a waiting period during which pressure on a first axial end of the plugging head and a second axial end of the plugging head are equalized. Equalization occurs as pressure is released through the first equalizer valve, i.e., as fluid flows through the equalizer valve. Pressure may be monitored within the pipeline using one or more pressure gauges.

In Block 176, the first equalizer valve is optionally closed. With the pressure equalized, the equalizer valve may no longer be needed. Alternatively, the first equalizer valve may remain open and fluid may continue flowing through the equalizer valve. In Block 178, the plugging head is retracted from the pipeline into the containment machine housing via the retractable arm. In Block 180, the containment machine is disconnected from the pipeline. The pipeline may return to its normal function. The containment machine may be used for subsequent plugging operations. The first equalizer valve may be closed when it is not in use.

In one or more embodiments, fluid may be continuously flowed or contained within a sealed segment of the pipeline during one, some, or all of the steps outlined in FIGS. 6 and 7.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A pipeline plugging system, comprising:
a containment machine, comprising:
a containment machine housing connected to a pipeline,
a plugging head assembly, comprising:
a plugging head disposed within the pipeline,
a seal positioned radially around the plugging head,
a channel fluidly connecting a first opening at a first axial end of the plugging head and a second opening at a second axial end of the plugging head, and
a first equalizer valve positioned along the channel; and
a retractable arm coupling the plugging head assembly to an actuator.

2. The pipeline plugging system of claim 1, further comprising a pressure measurement port disposed on an axial end of the plugging head.

3. The pipeline plugging system of claim 1, further comprising a second equalizer valve disposed on the containment machine housing, wherein the second equalizer valve is fluidly connected to the first equalizer valve via a first hose.

4. The pipeline plugging system of claim 3, further comprising a third equalizer valve disposed on the containment machine housing, wherein the third equalizer valve is fluidly connected to the second equalizer valve via a second hose.

5. The pipeline plugging system of claim 3, further comprising a fourth equalizer valve disposed on a distal section of the pipeline, wherein the fourth equalizer valve is fluidly connected to the second equalizer valve via a passage.

6. A method for plugging a pipeline, comprising:
connecting a containment machine to the pipeline;
extending a plugging head from a containment machine housing into the pipeline via a retractable arm;
sealing the plugging head within the pipeline via a seal positioned radially between the plugging head and an inner surface of the pipeline; and
operating a first equalizer valve, wherein the first equalizer valve is fluidly connected to a channel extending axially through the plugging head;
wherein during the extending, sealing, and operating, fluid is continuously flowed through the pipeline.

7. The method of claim 6, further comprising measuring a pressure on an axial end of the plugging head.

8. The method of claim 7, wherein the first equalizer valve is opened when the pressure measurement is above a pressure threshold.

9. The method of claim 6, further comprising performing a repair before operating the first equalizer valve.

10. The method of claim 6, further comprising performing a hot tapping operation on the pipeline before connecting the containment machine.

11. The method of claim 6, wherein the containment machine is connected to the pipeline via a flange.

12. The method of claim 6, further comprising operating a second equalizer valve, wherein the second equalizer valve is disposed on the containment machine housing and wherein the second equalizer valve is fluidly connected to the first equalizer valve via a first hose.

13. The method of claim 12, further comprising operating a third equalizer valve, wherein the third equalizer valve is disposed on the containment machine housing and wherein the third equalizer valve is fluidly connected to the second equalizer valve via a second hose.

14. The method of claim 12, further comprising operating a fourth equalizer valve, wherein the fourth equalizer valve is disposed on a distal section of the pipeline and wherein the fourth equalizer valve is fluidly connected to the second equalizer valve via a passage.

15. A method for plugging a pipeline, comprising:
connecting a containment machine to the pipeline;
extending a plugging head from a containment machine housing into the pipeline via a retractable arm;
sealing the plugging head within the pipeline via a seal positioned radially between the plugging head and an inner surface of the pipeline;
opening a first equalizer valve disposed on the plugging head, wherein the first equalizer valve is fluidly connected to a channel extending axially through the plugging head;
waiting until a pressure at a first axial end of the plugging head and a pressure at a second axial end of the plugging head are equalized;
retracting the plugging head from the pipeline into the containment machine housing via the retractable arm; and
disconnecting the containment machine from the pipeline.

16. The method of claim 15, further comprising performing a repair before opening the first equalizer valve.

17. The method of claim 15, further comprising performing a hot tapping operation on the pipeline before connecting the containment machine.

18. The method of claim 15, further comprising opening a second equalizer valve, wherein the second equalizer valve is disposed on the containment machine housing and wherein the second equalizer valve is fluidly connected to the first equalizer valve via a first hose.

19. The method of claim 17, further comprising opening a third equalizer valve, wherein the third equalizer valve is disposed on the containment machine housing and wherein the third equalizer valve is fluidly connected to the second equalizer valve via a second hose.

20. The method of claim 17, further comprising opening a fourth equalizer valve, wherein the fourth equalizer valve is disposed on a distal section of the pipeline and wherein the fourth equalizer valve is fluidly connected to the second equalizer valve via a passage.
